(19) United States
(12) Patent Application Publication
(10) Pub. No.: US 2026/0012752 A1
(43) Pub. Date: Jan. 8, 2026

(54) AUTHORIZATION TO DE-ANONYMIZE A TRACKING TAG

(71) Applicant: Motorola Mobility LLC, Chicago, IL (US)

(72) Inventors: Amit Kumar Agrawal, Bangalore (IN); Panduranga Reddy Pailla, Bangalore (IN); Vijayprakash Idlur, Bangalore (IN); Michael E. Russell, Lake Zurich, IL (US)

(73) Assignee: Motorola Mobility LLC, Chicago, IL (US)

(21) Appl. No.: 18/765,609

(22) Filed: Jul. 8, 2024

(51) Int. Cl. H04W 4/029; H04W 12/30

(52) U.S. Cl. CPC H04W 4/029; H04W 12/30

(57) ABSTRACT

In aspects of authorization to de-anonymize a tracking tag, a mobile device implements a tracking manager to receive authorization from an additional mobile device to de-anonymize an identity of a tracking tag in an environment of the mobile device. The tracking manager identifies the tracking tag in the environment of the mobile device and tracks a location of the tracking tag. The tracking manager then causes display of tracking information in a user interface of a mobile device, the tracking information indicating at least the location of the tracking tag and the identity of the tracking tag.

### BACKGROUND

Ultra-wideband (UWB) is an example of a radio technology that can be used to locate objects or people using low energy short-range, high-bandwidth communications. The UWB technology supports accurate relative position tracking and provides for applications using relative distance between entities. Notably, UWB utilizes two-way ranging between devices and provides for highly precise positioning for time-of-flight (ToF) and angle-of-arrival (AoA) measurements.

### BRIEF DESCRIPTION OF THE DRAWINGS

Implementations of the techniques for authorization to de-anonymize a tracking tag are described with reference to the following Figures. The same numbers may be used throughout to reference like features and components shown in the Figures.

FIG. 1 illustrates an example system for authorization to de-anonymize a tracking tag in accordance with one or more implementations as described herein.

FIG. 2 illustrates an example of authorization to de-anonymize a tracking tag in accordance with one or more implementations as described herein.

FIG. 3 illustrates an example user interface of authorization to de-anonymize a tracking tag, including a tracking map, in accordance with one or more implementations as described herein.

FIG. 4 illustrates an additional example user interface of authorization to de-anonymize a tracking tag, including tracking directions, in accordance with one or more implementations as described herein.

FIG. 5 illustrates an additional example user interface of authorization to de-anonymize a tracking tag, including an authorizer's view of the tracking map, in accordance with one or more implementations as described herein.

FIG. 6 illustrates an additional example user interface of authorization to de-anonymize a tracking tag, including revoking the authorization, in accordance with one or more implementations as described herein.

FIG. 7 illustrates an additional example user interface of authorization to de-anonymize a tracking tag, including authorization selections, in accordance with one or more implementations as described herein.

FIGS. 8-10 illustrate example methods for authorization to de-anonymize a tracking tag in accordance with one or more implementations of the techniques described herein.

FIG. 11 illustrates various components of an example device that may be used to implement the techniques for authorization to de-anonymize a tracking tag as described herein.

### DETAILED DESCRIPTION

Implementations of the techniques for authorization to de-anonymize a tracking tag may be implemented as described herein. A mobile device, such as any type of a wireless device, media device, mobile phone, flip phone, client device, tablet, computing, communication, entertainment, gaming, media playback, and/or any other type of computing and/or electronic device, or a system of any combination of such devices, may be configured to perform techniques for authorization to de-anonymize a tracking tag as described herein. In one or more implementations, a mobile device includes a tracking manager, which can be used to implement aspects of the techniques described herein.

Tracking tags, such as ultra-wideband (UWB) tags, are usable for tracking locations of objects or people within a close range. For instance, a tracking tag is attached to an object and emits tracking signals, which are short pulses of tracking radio waves that are usable to track the object. A tracking receiver, which may be implemented in a mobile device, receives the tracking signals. The mobile device then determines a location of the tracking tag relative to the tracking receiver based on time-of-flight and angle-of-arrival measurements of the tracking signals.

Although the tracking tags have a high degree of accuracy for close-range tracking, the tracking tags may be untraceable outside a tracking range, which is typically 150 meters for UWB tags, for example. This renders tracking tags unusable to track an object when the tracking receiver is outside the tracking range. For instance, a parent attaches a tracking tag to a child's shoe to track the child's location. This works when the parent is within the tracking range of the child, but the parent is no longer able to track the child when the parent leaves the tracking range around the tracking tag, such as when the child goes to the park with a grandparent. For example, the tracking tag may be detected by multiple devices in an environment but appears anonymous to the devices unless they know an identity of the tracking tag. For instance, the tracking tag has a unique identifier that links the tracking tag to a specific object or person. Without knowing the unique identifier, a device is unable to track the specific object or person, because the tracking tag that corresponds to the specific object or person is anonymous. For this reason, the grandparent's mobile device is unable to identify the tracking tag associated with the child, and is therefore unable to track the child.

Conventional systems attempt to address these challenges by using devices that emit secure Bluetooth signals that can be detected by nearby devices that communicate a location of the device to a user's mobile device. Although these conventional systems are useful to view a detected location of a tracked object remotely and securely, they are unhelpful for obtaining the tracked object remotely because the identity of the device is unknown to the nearby devices that communicate the location of the device to the user's mobile device. In the above example, the parent may be able to view the detected location of the child while the child is at the park with the grandparent, but if the child becomes lost, the parent is unable to assist the grandparent in locating the child because the parent is not at the park.

Techniques and systems are described for authorization to de-anonymize a tracking tag, which addresses these challenges. This involves receiving authorization at a mobile device (e.g., grandparent's device) from an additional mobile device (e.g., parent's device) to de-anonymize an identity of a tracking tag (e.g., of the child) in the environment. The authorized, mobile device is closer to the tracking tag than the additional mobile device and is able to identify the tracking tag and track a location of the tracking tag, while also transmitting tracking information back to the additional mobile device. These techniques are also an improvement over the conventional systems, thereby allowing the additional mobile device to view the location of the tracking tag, even while the additional mobile device is outside the tracking range, because the additional mobile device relies on the mobile device to track the tracking tag. Additionally, because the mobile device also knows the identity of the tracking tag and is in a vicinity of the tracking tag, the user of the mobile device is actually in a position to locate the tracking tag, unlike the user of the additional mobile device, which may be in a remote location.

In aspects of the described techniques, a tracking manager provides authorization to the mobile device from the additional mobile device to de-anonymize an identity of the tracking tag. Following the above example, the additional mobile device is associated with the parent, and the tracking tag is incorporated into the child's shoe. The identity of the tracking tag is not anonymous to the additional mobile device, and the additional mobile device therefore has an ability to track the tracking tag. However, the child is going to the park with the grandparent, and the parent wants the grandparent to be able to track the child. For instance, because the tracking range is limited, the additional mobile device may be unable to track the tracking tag while the child is at the park and away from the parent. Because of this, the mobile device, which is associated with the grandparent, receives the authorization to de-anonymize the identity of the tracking tag and therefore track the child wearing the tracking tag.

After authorization by the additional mobile device, the tracking manager of the additional mobile device may share a unique identifier with the mobile device that identifies the tracking tag associated with the object person or object being tracked, which is the child in this example. The tracking manager then tracks a location of the tracking tag using the mobile device. For instance, the mobile device is within the tracking range to the tracking tag and receives the tracking signals emitted from the tracking tag. The tracking manager may compare the signal path loss from the received signals to determine that the tracking tag and the mobile device are proximate each other in the environment based on similar signal path loss. Based on the position information, the tracking manager may track an exact location of the tracking tag.

In some implementations, the tracking manager of the additional mobile device limits the authorization to de-anonymize the identity of the tracking tag to a predetermined amount of time. For instance, the tracking manager automatically terminates the authorization at an expiration of the predetermined amount of time. In this example implementation, the parent is able to choose a time when the tracking manager revokes the authorization to de-anonymize the identity of the tracking tag, and the additional mobile device returns to being the only device able to track the tracking tag.

While the mobile device is tracking the tracking tag, the tracking manager causes display of tracking information in a user interface of the mobile device. The tracking information may be presented as a map illustrating the location of the tracking tag. In some implementations, the tracking manager may also generate step-by-step directions guiding a user of the mobile device to the tracking tag. For example, the grandparent can view a map in the user interface of the mobile device indicating the current location of the child. If the child gets lost, the grandparent may also view the step-by-step directions generated by the tracking manager to guide the grandparent to the child's location.

Because the additional mobile device may be out of tracking range and unable to track the tracking tag itself, the tracking manager may also provide the additional mobile device with the tracking information. For example, the parent may also view the current location of the child on the map presented in the user interface of the additional mobile device for peace of mind, even though the parent is not in the vicinity of the child.

While features and concepts of the described techniques for authorization to de-anonymize a tracking tag is implemented in any number of different devices, systems, environments, and/or configurations, implementations of the techniques for authorization to de-anonymize a tracking tag are described in the context of the following example devices, systems, and methods.

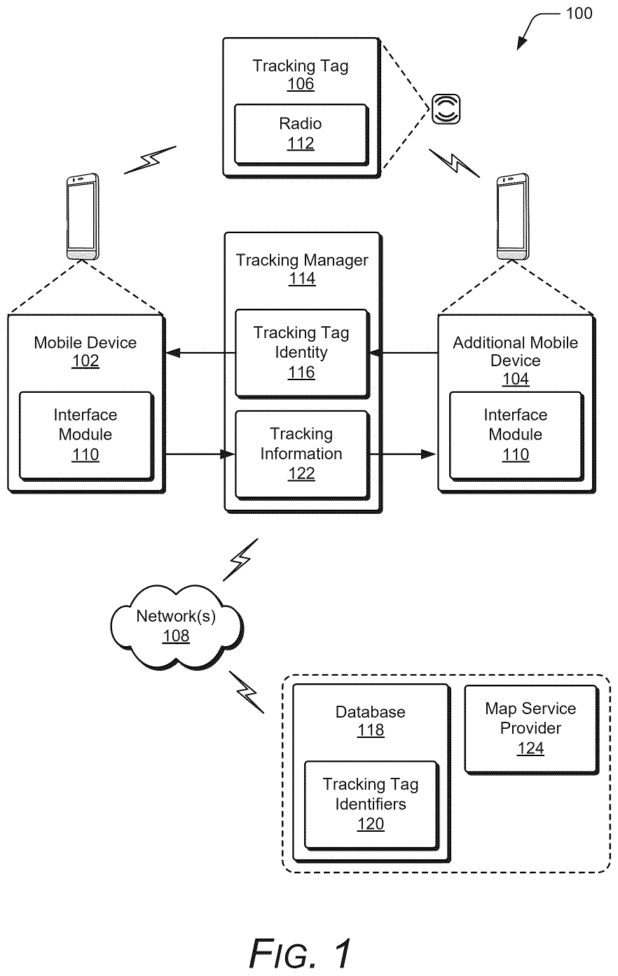

FIG. 1 illustrates an example system 100 for authorization to de-anonymize a tracking tag, as described herein. The system 100 includes a mobile device 102, an additional mobile device 104, a tracking tag 106, and a communication network 108. Examples of the mobile device 102 and the additional mobile device 104 include at least one of any type of a wireless device, mobile device, mobile phone, flip phone, client device, companion device, tablet, computing device, communication device, entertainment device, gaming device, media playback device, any other type of computing and/or electronic device.

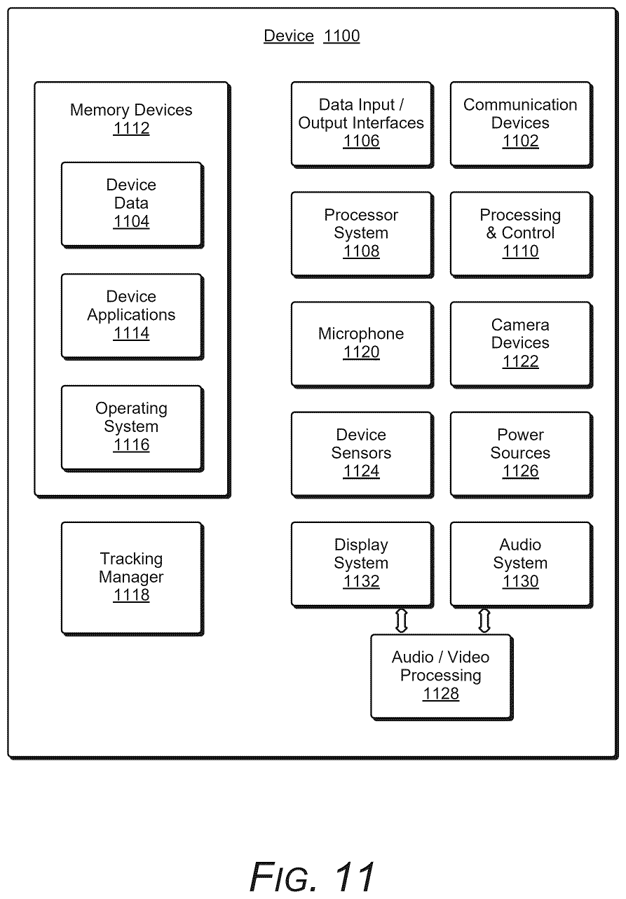

The mobile device 102 and the additional mobile device 104 can be implemented with various components, such as a processor system and memory, as well as any number and combination of different components as further described with reference to the example device shown in FIG. 11. In implementations, the mobile device 102 and the additional mobile device 104 include various radios for wireless communication with other devices. For example, the system and devices can include a Bluetooth (BT) and/or Bluetooth Low Energy (BLE) transceiver, as well as a near field communication (NFC) transceiver. In some cases, the system and devices include at least one of a WiFi radio, a cellular radio, a global positioning satellite (GPS) radio, or any available type of device communication interface.

In some implementations, the devices, applications, modules, servers, and/or services described herein communicate via the communication network 108, such as for data communication with the mobile device 102 and the additional mobile device 104. The communication network 108 includes a wired and/or a wireless network. The communication network 108 is implemented using any type of network topology and/or communication protocol, and is represented or otherwise implemented as a combination of two or more networks, to include IP-based networks, cellular networks, and/or the Internet. The communication network 108 includes mobile operator networks that are managed by a mobile network operator and/or other network operators, such as a communication service provider, mobile phone provider, and/or Internet service provider.

The mobile device 102 and the additional mobile device 104 include various functionalities that enable the devices to implement different aspects of authorization to de-anonymize a tracking tag, as described herein. In one or more examples, an interface module 110 represents functionality (e.g., logic and/or hardware) enabling the mobile device 102 and the additional mobile device 104 to interconnect and interface with other devices and/or networks, such as the communication network 108. For example, the interface module 110 enables wireless and/or wired connectivity of the mobile device 102 and the additional mobile device 104.

The mobile device 102 and the additional mobile device 104 can include and implement various device applications, such as any type of messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display screen of the mobile device 102 or the additional mobile device 104. Generally, an application user interface, or any other type of video, image, graphic, and the like is digital image content that is displayable on the display screen of the mobile device 102 and the additional mobile device 104.

In implementations, the mobile device 102 and the additional mobile device 104 may be communicatively linked, generally by wireless connection, to a radio 112, such as a UWB radio of the tracking tag 106 and/or to other UWB-enabled devices for UWB communication in the environment. The tracking tag 106 may be associated with any type of device in the environment, to include any type of a smart device, media device, mobile device, wireless device, and/or electronic device, as well as associated with a static object or device that is not enabled for wireless communications. For example, the tracking tag 106 may be incorporated into a child's sneakers or other clothing item to track the child. The mobile device 102 and the additional mobile device 104 can communicate with the tracking tag 106 and receive position information from the tracking tag 106. For example, the mobile device 102 and the additional mobile device 104 can receive position information from the tracking tag 106 and compare the signal path loss from the received signals to determine that the tracking tag 106 and the mobile device 102 and/or the additional mobile device 104 are proximate each other in the environment based on similar signal path loss.

The tracking tag 106 may be detected by multiple devices in an environment, but the tracking tag 106 appears anonymous to devices unless a device knows an identity of the tracking tag 106. For instance, the tracking tag 106 has a unique identifier that links the tracking tag 106 to a specific object or person. In the above example, for instance, the unique identifier indicates that the tracking tag 106 corresponds to the child. Without knowing the unique identifier, a device is unable to track the specific object or person, because the tracking tag 106 that corresponds to the specific object or person is anonymous. This preserves security by not allowing unauthorized devices to identify the tracking tag 106, thereby preventing the unauthorized devices from tracking the tracking tag 106. For instance, unauthorized devices that do not know the unique identifier are unable to identify that the tracking tag 106 corresponds to the child and are therefore unable to track the child.

In this example system 100, the tracking tag 106 is generally representative of any tracking device in the environment and can include various radios for wireless communications with other devices and/or with the other tracking tags in the environment, such as other UWB tags. For example, the tracking tag 106 can include the radio 112, as well as any other types of radio devices, such as a UWB radio, a Bluetooth radio, a Wi-Fi radio, and/or a global positioning system (GPS) radio implemented for wireless communications with the other devices and tracking tags in the environment. The mobile device 102 and the additional mobile device 104 can also include various radios for wireless communication with other mobile devices and/or with the tracking tag 106 in the environment. For example, the mobile device 102 includes a radio, such as a UWB radio, and may include other radio devices, such as a Bluetooth radio, a Wi-Fi radio, and a GPS radio implemented for wireless communications with the other devices and tracking tag 106 in the environment.

In implementations, the mobile device 102, the additional mobile device 104, and/or the tracking tag 106 may include any type of positioning system, such as a GPS transceiver or other type of geo-location device, to determine the geographical location of the mobile device 102, the additional mobile device 104, and/or the tracking tag 106. Notably, any of the devices described herein, to include components, modules, services, computing devices, camera devices, and/or the tracking tags, can share the GPS data between any of the devices, whether they are GPS-hardware enabled or not. Although the resolution of global positioning is not as precise as the local positioning provided by UWB tracking technology, the GPS data that is received by the GPS-enabled devices can be used for confirmation that the devices are all generally located in the environment, which is confirmed by the devices that are also tracking-enabled and included in the environment mapping. The GPS location of devices can be determined based on their relative position in the environment and their proximity to the GPS-enabled devices. Accordingly, changes in location of both GPS-enabled devices and non-GPS devices can be tracked based on global positioning and local positioning in the environment.

In the example system 100 for authorization to de-anonymize a tracking tag, the mobile device 102 and/or the mobile device 102 implements a tracking manager 114 (e.g., as a device application). As shown in this example, the tracking manager 114 represents functionality (e.g., logic, software, and/or hardware) enabling aspects of the described techniques for authorization to de-anonymize a tracking tag. The tracking manager 114 can be implemented as computer instructions stored on computer-readable storage media and can be executed by a processor system of the mobile device 102 and/or the additional mobile device 104. Alternatively, or in addition, the tracking manager 114 can be implemented at least partially in hardware of the device.

In one or more implementations, the tracking manager 114 includes independent processing, memory, and/or logic components functioning as a computing and/or electronic device integrated with the mobile device 102 and/or the additional mobile device 104. Alternatively, or in addition, the tracking manager 114 can be implemented in software, in hardware, or as a combination of software and hardware components. In this example, the tracking manager 114 is implemented as a software application or module, such as executable software instructions (e.g., computer-executable instructions) that are executable with a processor system of the mobile device 102 and/or the additional mobile device 104 to implement the techniques and features described herein. As a software application or module, the tracking manager 114 can be stored on computer-readable storage memory (e.g., memory of a device), or in any other suitable memory device or electronic data storage implemented with the controller. Alternatively or in addition, the tracking manager 114 is implemented in firmware and/or at least partially in computer hardware. For example, at least part of the tracking manager 114 is executable by a computer processor, and/or at least part of the content manager is implemented in logic circuitry.

In this example system 100, the tracking manager 114 of the additional mobile device 104 provides authorization to the mobile device 102 to de-anonymize an identity 116 of the tracking tag 106. For instance, the additional mobile device 104 is associated with a parent of a child, and the tracking tag 106 is incorporated into the child's clothing. The identity of the tracking tag 106 is not anonymous to the additional mobile device 104, and the additional mobile device 104 therefore has a permanent ability to track the tracking tag 106. However, the parent is leaving the child with a trusted relative and wants the trusted relative to be able to track the child. Moreover, because tracking ranges for tracking tags are limited, the additional mobile device 104 may be unable to track the tracking tag 106 while the child is staying with the trusted relative. For instance, for UWB and Bluetooth Low Energy Radios, a typical tracking range is 150 meters, and the parent will be unable to track the tracking tag 106 using the additional mobile device 104 because the parent will be further than 150 meters from the tracking tag 106. Because of this, the parent wants the trusted relative to be able to track the child temporarily while the parent is not nearby. To allow the trusted relative to track the child for a temporary period of time, authorization to de-anonymize the identity 116 of the tracking tag 106 is transmitted to the mobile device 102, which is associated with the trusted relative, from the additional mobile device 104 associated with the parent.

After authorization to de-anonymize the identity 116 of the tracking tag 106 is received from the additional mobile device 104, the tracking manager 114 may share a unique identifier with the mobile device 102 that identifies the tracking tag 106 associated with the object person or object being tracked, which is the child in this example. Because the authorization may be temporary, the unique identifier may be configured to expire at a predetermined amount of time. In some examples, to determine which unique identifier to provide to the mobile device 102, the tracking manager 114 may access a database 118 including tracking tag identifiers 120 via the communication network 108 to de-anonymize the identity 116 of the tracking tag 106. For instance, the tracking manager 114 communicates the identity 116 of the tracking tag 106 to the mobile device 102, and the tracking manager 114 identifies the tracking tag 106 in the environment of the mobile device 102 based on the identity 116.

The tracking manager 114 tracks a location of the tracking tag 106 using the mobile device 102. For instance, the mobile device 102 is within tracking range to the tracking tag 106 and receives position information from the tracking tag 106. The tracking manager 114 may compare the signal path loss from the received signals to determine that the tracking tag 106 and the mobile device 102 are proximate each other in the environment based on similar signal path loss. Based on the position information, the tracking manager 114 may track an exact location of the tracking tag 106.

In some implementations, the tracking manager 114 limits the authorization to de-anonymize the identity of the tracking tag 106 to a predetermined amount of time. For instance, the tracking manager 114 automatically terminates the authorization at an expiration of the predetermined amount of time. In some implementations, terminating the authorization involves providing a unique identifier that expires, re-setting the unique identifier for the tracking tag 106 being tracked, or otherwise blocking the mobile device 102 from further tracking the tracking tag 106. The predetermined amount of time may also be dependent on completion of a specified event, such as when the additional mobile device 104 returns to a specific proximity or within the tracking range of the tracking tag 106.

The tracking manager 114 causes display of tracking information 122 in a user interface of the mobile device 102 while the mobile device 102 has the authorization to de-anonymize the identity 116 of the tracking tag 106. The tracking information 122 indicates the location of the tracking tag 106 and the identity 116 of the tracking tag 106. For example, the tracking manager 114 generates a map for display in the user interface of the mobile device 102, illustrating the location of the tracking tag 106 using map information provided by a map service provider 124 via the communication network 108. The map, for example, may feature a marker that indicates the identity 116 of the tracking tag 106 and the location of the tracking tag 106 in the environment. In some implementations, the tracking manager 114 may also generate step-by-step directions guiding a user of the mobile device 102 to the tracking tag 106.

Because the additional mobile device 104 may be out of tracking range and unable to track the tracking tag 106 itself, the additional mobile device 104 relies on the mobile device 102 to collect the tracking information 122 and to provide the additional mobile device 104 with the tracking information 122. The tracking manager 114 may establish a communication interface to communicate the tracking information 122 to the additional mobile device 104. For instance, the communication interface may allow the user of the additional mobile device 104 to send a direct message to the mobile device 102 related to tracking the tracking tag 106. The tracking manager 114 may also generate the map for display in the user interface of the additional mobile device 104. In some example implementations, the map may include a marker that indicates a location of the mobile device 102 in addition to the marker that indicates the identity 116 of the tracking tag 106 and the location of the tracking tag 106 in the environment. This way, the user of the additional mobile device 104 may view the location of both the tracking tag 106 and the mobile device 102 from a remote location, to ensure that the user of the mobile device 102, who is trusted to track the tracking tag 106, remains nearby the tracking tag 106.

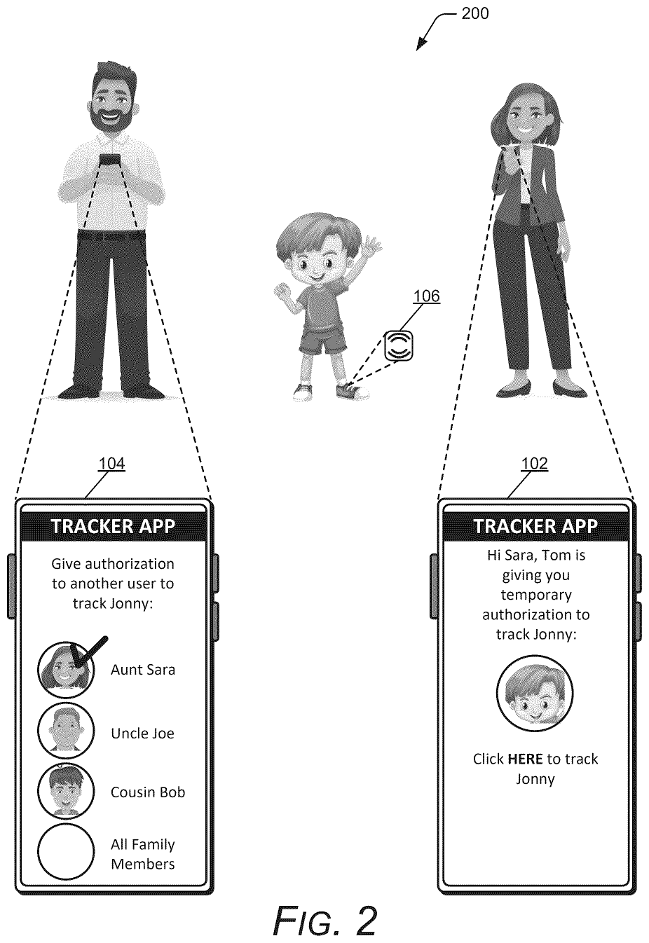

FIG. 2 illustrates example 200 of authorization to de-anonymize a tracking tag, as described herein. In this example 200, a tracking tag 106 is incorporated into a child's shoe. Because the child, Jonny, is too young to own a mobile device, the purpose of the tracking tag 106 is to track the child without tracking a mobile device. For instance, an additional mobile device 104 is associated with the child's father and is configured to track the tracking tag 106.

The tracking tag 106 can include various radios for wireless communications with other devices and/or with the other tracking tags in the environment. For example, the tracking tag 106 can include a radio 112, such as a UWB radio, as well as any other types of radio devices, such as a Bluetooth radio, a Wi-Fi radio, and/or a global positioning system (GPS) radio implemented for wireless communications with the other devices and tracking tags in the environment. The additional mobile device 104 in this example can also include various radios for wireless communication with other mobile devices, such as the additional mobile device 104, and/or with the tracking tag 106 in the environment. For example, the mobile device 102 includes a UWB radio and may include other radio devices, such as a Bluetooth radio, a Wi-Fi radio, and a GPS radio implemented for wireless communications with the other devices and tracking tag 106 in the environment.

In this example, the child is visiting the park with his Aunt Sara while his father runs errands. The tracking manager 114 generates a prompt for display in the user interface of the additional mobile device 104 for the child's father to select a mobile device 102 associated with another user for authorization to track Jonny. Without the authorization, the mobile device 102 is unable to track Jonny. For instance, the tracking tag 106 appears anonymous to devices unless a device knows an identity of the tracking tag 106. For instance, the tracking tag 106 has a unique identifier that links the tracking tag 106 to a specific object or person, which is Jonny in this example. The unique identifier is known to the additional mobile device 104, and therefore Jonny's father is able to track Jonny. Other mobile devices in the environment, however, so not know the unique identifier. Without knowing the unique identifier, the devices unable to track Jonny because the tracking tag 106 that corresponds to the specific object or person is anonymous.

In this example, Jonny's father will be out of tracking range with the tracking tag 106 while Jonny visits the park with Sara, so the additional mobile device 104 will not be able to track Jonny. Jonny's father therefore selects “Aunt Sara” from a list of family members displayed in the user interface of the additional mobile device 104. The tracking manager 114 therefore provides the mobile device 102, which is associated with Sara, with authorization to de-anonymize the identity 116 of the tracking tag 106 and therefore track Jonny, who is wearing the tracking tag 106.

To provide the authorization to de-anonymize the identity 116 of the tracking tag 106, the tracking manager 114 may share the unique identifier of the tracking tag 106 with the mobile device 102. In some implementations, to determine which unique identifier to provide to the mobile device 102, the tracking manager 114 may access a database 118 including tracking tag identifiers 120 via the communication network 108 to de-anonymize the identity 116 of the tracking tag 106. For instance, the tracking manager 114 communicates the identity 116 of the tracking tag 106 to the mobile device 102, and the tracking manager 114 identifies the tracking tag 106 in the environment of the mobile device 102 based on the identity 116.

In response to receiving the authorization to de-anonymize the identity 116 of the tracking tag 106, the mobile device 102 receives an alert from the tracking manager 114 in the user interface of the mobile device 102 telling Sara that she is given temporary authorization to track Jonny. In some implementations, the tracking manager 114 causes display of an indication of an expiration time for the authorization to de-anonymize the identity 116 of the tracking tag 106, or an expiration time for tracking the tracking tag 106, in the user interface of the mobile device 102. Additionally, in some implementations the tracking manager 114 causes the mobile device 102 to display a communication interface to communicate with the additional mobile device 104 while the mobile device 102 has the authorization to de-anonymize the identity 116 of the tracking tag 106. For instance, Sara may reply by saying “Yes, I will keep track of where Jonny is when we are in the park.”

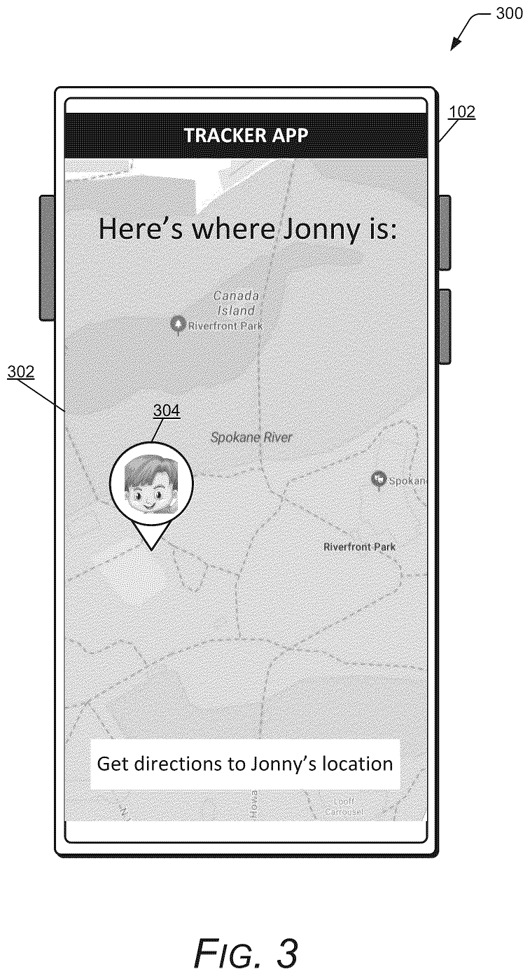

FIG. 3 illustrates example 300 user interface of authorization to de-anonymize a tracking tag, including a tracking map, as described herein. The example 300 is a continuation of the example 200. In this example 300, the tracking manager 114 causes display of a map 302 in the user interface of the mobile device 102 with a Tracking tag location marker 304 indicating a location of the tracking tag 106.

For instance, after the mobile device 102 receives the authorization to de-anonymize the identity 116 of the tracking tag 106, the tracking manager 114 causes display of a prompt in the user interface of the mobile device 102 to track the tracking tag 106. While tracking the tracking tag 106, the tracking manager 114 generates the map 302 for display in the user interface of the mobile device 102. The map 302 is a map of the environment of the tracking tag 106 being tracked by the mobile device 102. In some implementations, the map 302 may be a road map, a topographical map, a satellite image map, or any other type of map of the environment of the tracking tag 106.

In this example implementation, the map 302 includes a Tracking tag location marker 304, which indicates a precise location of the tracking tag 106 in the environment on the map 302. Because the unique identifier for the tracking tag 106 is temporarily known to the mobile device 102, the user of the mobile device 102, Sara, is able to track Jonny using the Tracking tag location marker 304 on the map 302. Additionally, in this implementation, because the unique identifier for the tracking tag 106 is temporarily known to the mobile device 102, the tracking tag location marker 304 displays an image of Jonny's face on the Tracking tag location marker 304, indicating to Sara what the Tracking tag location marker 304 represents on the map. For example, in some example implementations, multiple objects or people may be available to track using tracking tags, so the image may help differentiate between different tracking tag location markers.

In some implementations, the map 302 dynamically adjusts based on a detected location of the mobile device 102 relative to the location of the tracking tag 106. For instance, if Sara moves away from Jonny, the map may automatically zoom out to display a full range of space between Sara's detected location and the location of the tracking tag 106. Conversely, as Sara moves closer to Jonny, the map may automatically zoom in to display more detail of space between Sara's detected location and the location of the tracking tag 106. Additionally, in some example implementations, the tracking manager 114 may also display a marker depicting Sara's detected location on the map 302, so that it is clear where Jonny is located compared to where Sara is located.

Because some users may prefer a different format to track a location of a person or an object associated with a tracking tag, the tracking manager 114 may also provide an option to change a format of the map 302 in the user interface. In this example, for instance, the user interface includes a prompt to “get directions to Jonny's location.”

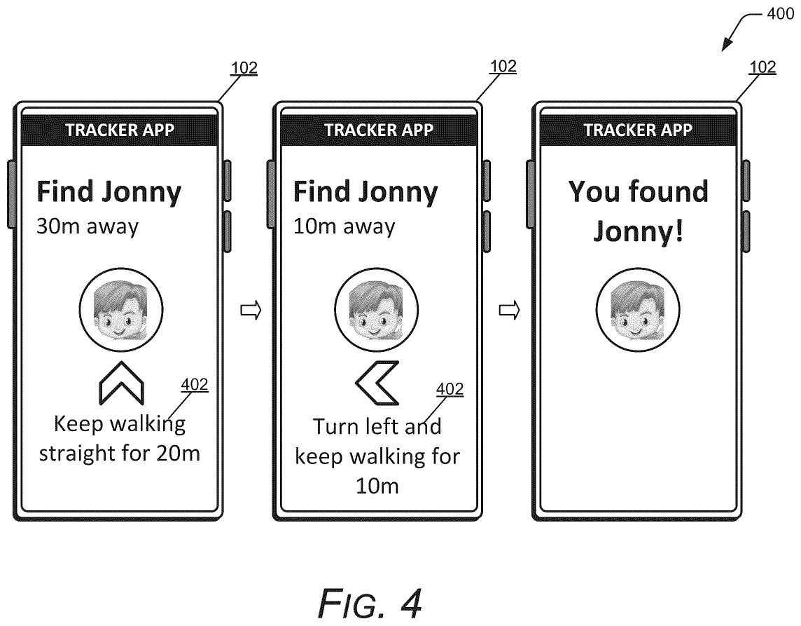

FIG. 4 illustrates example 400 user interface of authorization to de-anonymize a tracking tag, including tracking directions, as described herein. The example 400 is a continuation of the example 300. In this example 400, the tracking manager 114 causes display of directions 402 in the user interface of the mobile device 102 to the location of the tracking tag 106.

For instance, after the tracking manager 114 receives an input selection at the mobile device 102 in response to the prompt to “get directions to Jonny's location,” the tracking manager 114 determines step-by-step directions to the location of the tracking tag 106. The tracking manager 114 then generates visual indications including a series of step-by-step directions for display in the user interface of the mobile device 102.

In this example implementation, the tracking manager 114 determines the detected location of Sara in relation to the location of the tracking tag 106 associated with Jonny. For instance, Sara begins 30 meters away from Jonny, and the directions 402 instruct Sara to “keep walking straight for 20 m.” The tracking manager 114 continues to monitor Sara's location (i.e., the location of the mobile device 102) and Jonny's location (i.e., the location of the tracking tag 106). After Sara walks straight for 20 meters, the directions 402 update and instruct Sara to “turn left and keep walking for 10 m.” Again, the tracking manager 114 continues to monitor Sara's location and Jonny's location. After Sara turns left and walks straight for 10 meters, the directions 402 update and alert Sara that she found Jonny. In this manner, the directions 402 aid users of the mobile device 102 to locate the tracking tag 106 in situations with confusing terrain or streets, where the users may struggle to locate the tracking tag 106 with the map 302.

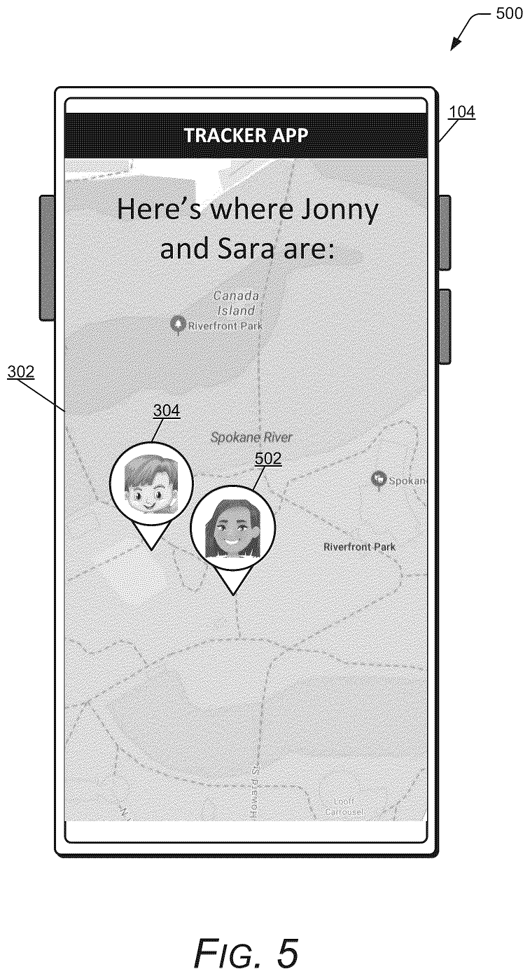

FIG. 5 illustrates example 500 user interface of authorization to de-anonymize a tracking tag, including an authorizer's view of the tracking map, as described herein. The example 500 is a continuation of the example 400. In this example 500, the tracking manager 114 generates the map 302 for display in the user interface of the additional mobile device 104 with a Tracking tag location marker 304 indicating a location of the tracking tag 106 and a mobile device location marker 502 indicating a location of the mobile device 102.

Because the additional mobile device 104 may not be within tracking range of the tracking tag 106, the additional mobile device 104 may rely on the mobile device 102 to track the tracking tag 106. As a result, the tracking manager 114 transmits the tracking information 122 determined by the mobile device 102 to the additional mobile device 104. In some implementations, the tracking information 122 may be displayed in the form of the map 302 of the environment of the tracking tag 106. In some implementations, the map 302 may be displayed in a similar manner as the map 302 in the user interface of the mobile device 102, or a different type of map. For instance, the map 302 may be a road map, a topographical map, a satellite image map, or any other type of map of the environment of the tracking tag 106.

The map 302 includes the Tracking tag location marker 304, which indicates the precise location of the tracking tag 106 in the environment on the map 302. In this example implementation, the tracking tag location marker 304 displays an image of Jonny's face on the tracking tag location marker 304, indicating to Jonny's father what the tracking tag location marker 304 represents on the map. The map 302 may also include the mobile device location marker 502, which indicates the precise location of the mobile device 102 in the environment on the map 302. In this example implementation, the mobile device location marker 502 displays an image of Sara's face on the mobile device location marker 502, indicating to Jonny's father what the mobile device location marker 502 represents on the map. For instance, this allows Jonny's father to distinguish Sara's location from Jonny's location.

In some implementations, the map 302 dynamically adjusts based on a detected location of the mobile device 102 relative to the location of the tracking tag 106. For instance, if Sara moves away from Jonny, the map may automatically zoom out to display a full range of space between Sara's detected location and the location of the tracking tag 106. Conversely, as Sara moves closer to Jonny, the map may automatically zoom in to display more detail of space between Sara's detected location and the location of the tracking tag 106.

In one or more implementations, the tracking manager 114 may also provide alerts when the mobile device 102 and the tracking tag 106 travel a threshold distance away from each other. For example, this may indicate that the user of the mobile device 102 is failing to stay within the threshold distance of the tracking tag 106. Additionally or alternatively, the tracking manager 114 may also provide alerts when the Tracking tag 106 is traveling faster than a threshold speed, indicating that the tracking tag 106 may be inside a vehicle.

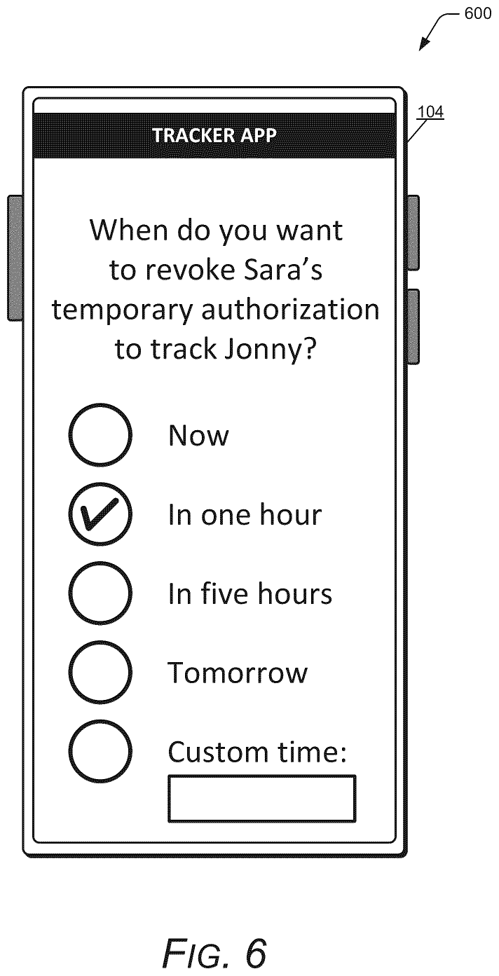

FIG. 6 illustrates example 600 user interface of authorization to de-anonymize a tracking tag, including revoking the authorization, as described herein. In this example 600, the tracking manager 114 causes display of a prompt in the user interface of the additional mobile device 104 to revoke the authorization to de-anonymize the identity of the tracking tag 106.

In some implementations, the tracking manager 114 limits the authorization to de-anonymize the identity of the tracking tag 106 to a predetermined amount of time. For example, the tracking manager 114 automatically terminates the authorization at an expiration of the predetermined amount of time. In some implementations, terminating the authorization involves providing a unique identifier that expires, re-setting the unique identifier for the tracking tag 106 being tracked, or otherwise blocking the mobile device 102 from further tracking the tracking tag 106.

In this example implementation, the tracking manager 114 generates a prompt for display in the user interface of the additional mobile device 104 asking the user “When do you want to revoke Sara's temporary authorization to track Jonny?” The tracking manager 114 causes display of options for specific times to revoke the authorization, including “Now,” “In one hour,” “In five hours,” or “Tomorrow. Additionally, the tracking manager 114 causes display of an input box for the user to input a custom time to revoke the authorization. For instance, Jonny's father may enter “three hours” into the input box, at which time the tracking manager 114 will revoke the authorization.

In some example implementations, the tracking manager 114 may alternatively revoke the authorization at completion of a specified event, such as when the additional mobile device 104 returns to a threshold distance from the tracking tag 106. For instance, Jonny's father comes back to pick him up at the park from Sara. Because the additional mobile device 104 is now nearby the tracking tag 106, the tracking manager 114 revokes the authorization to de-anonymize the identity of the tracking tag 106 from the mobile device 102.

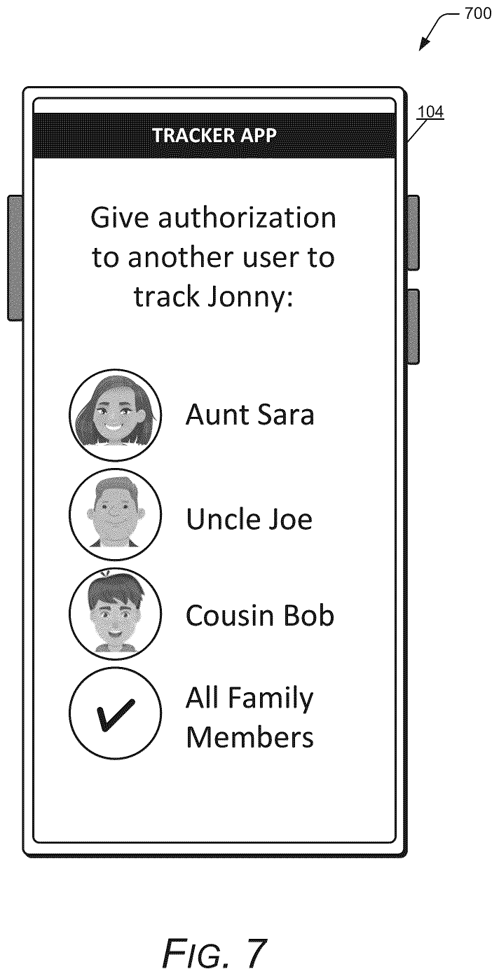

FIG. 7 illustrates example 700 user interface of authorization to de-anonymize a tracking tag, including authorization selections, as described herein. In this example 700, the tracking manager 114 causes display of options to transmit authorization to de-anonymize the identity 116 of the tracking tag 106 in the environment of the tracking tag 106.

In one or more implementations, a user may desire to allow multiple people to track the tracking tag 106. The tracking manager 114 therefore may provide a list of family members that the user may trust to track the tracking tag 106. The tracking manager 114 may make this determination based on contacts saved in the additional mobile device 104, communications, or other records associated with the user of the additional mobile device 104. Each of the contacts, for instance, may be associated with a specific user account that is known to the additional mobile device 104. This provides a group of trusted devices to potentially receive the authorization to de-anonymize the identity 116 of the tracking tag 106.

In this example implementation, the tracking manager 114 generates a prompt to transmit authorization to de-anonymize the identity 116 of the tracking tag 106 to “Aunt Sara,” “Uncle Joe,” or “Cousin Bob.” In addition, the tracking manager 114 generates a prompt to transmit authorization to de-anonymize the identity 116 of the tracking tag 106 to “All Family Members.” In this example, Jonny and his father may be at a family reunion. In case Jonny gets lost, his father selects the option to transmit authorization to de-anonymize the identity 116 of the tracking tag 106 to “All Family Members.” This allows the mobile devices associated with “Aunt Sara,” “Uncle Joe,” and “Cousin Bob” to identify the tracking tag 106 and therefore track the tracking tag 106 in the environment for a temporary period of time determined by Jonny's father.

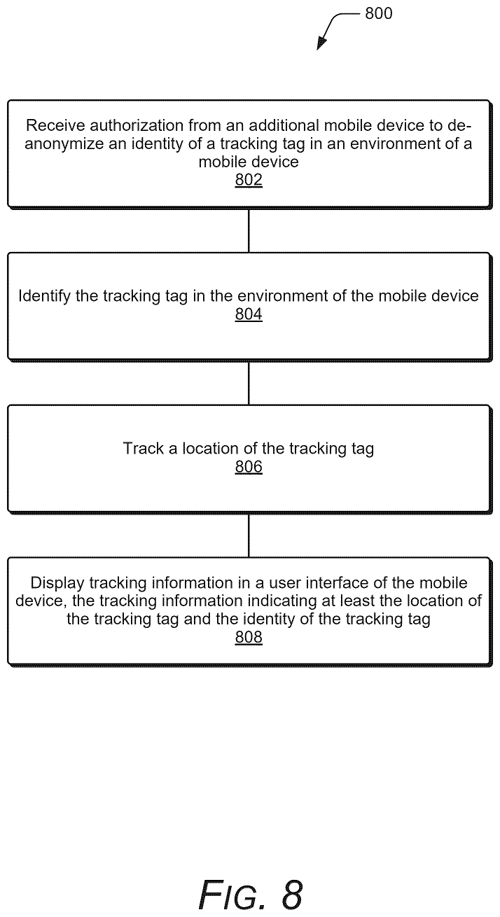

Example methods 800, 900, and 1000 are described with reference to respective FIGS. 8, 9, and 10 in accordance with one or more implementations of authorization to de-anonymize a tracking tag, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 8 illustrates example method(s) 800 for authorization to de-anonymize a tracking tag. The order in which the method is described is not intended to be construed as a limitation, and any number or combination of the described method operations may be performed in any order to perform a method, or an alternate method.

At 802, authorization is received from an additional mobile device to de-anonymize an identity of a tracking tag in an environment of the mobile device. For example, a tracking manager 114 receives authorization from an additional mobile device 104 to de-anonymize an identity 116 of a tracking tag in an environment of the mobile device 102. In some implementations, the tracking tag is an ultra-wideband (UWB) tag. Additionally, in some implementations, the mobile device 102 is part of a group of trusted devices that receive the authorization from the additional mobile device 104. For example, the mobile device 102 is associated with a specific user account that is known to the additional mobile device 104.

At 804, the tracking tag in the environment of the mobile device is identified. For example, the tracking manager 114 identifies the tracking tag in the environment of the mobile device 102.

At 806, a location of the tracking tag is tracked. For example, the tracking manager 114 tracks a location of the tracking tag. In some implementations, the tracking manager 114 causes the mobile device 102 to track the location of the tracking tag for a predetermined amount of time. For example, the tracking manager 114 causes the mobile device 102 to automatically terminate the authorization at an expiration of the predetermined amount of time.

At 808, tracking information is displayed in a user interface of the mobile device, the tracking information indicating at least the location of the tracking tag and the identity of the tracking tag. For example, the tracking manager 114 causes display of tracking information 122 in a user interface of the mobile device 102, the tracking information 122 indicating at least the location of the tracking tag and the identity 116 of the tracking tag. In some implementations, the tracking manager 114 causes the mobile device 102 to display a communication interface to facilitate communication related to the tracking information 122 with the additional mobile device 104. Additionally, in some implementations the user interface includes a map 302 indicating the location of the tracking tag. In some implementations, the user interface includes an indication of one or more directions 402 to locate the tracking tag.

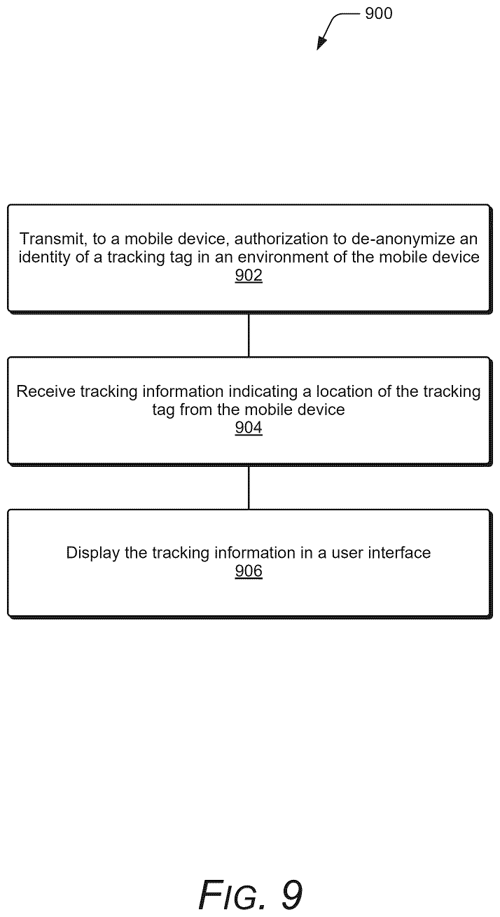

FIG. 9 illustrates example method(s) 900 for authorization to de-anonymize a tracking tag. The order in which the method is described is not intended to be construed as a limitation, and any number or combination of the described method operations may be performed in any order to perform a method, or an alternate method.

At 902, authorization is transmitted to a mobile device to de-anonymize an identity of a tracking tag in an environment of the mobile device. For example, a tracking manager 114 transmits, to a mobile device 102, authorization to de-anonymize an identity 116 of a tracking tag in an environment of the mobile device 102. In some implementations, the tracking manager 114 de-anonymizes the identity of the tracking tag for a predetermined amount of time. For example, the authorization is automatically terminated at an expiration of the predetermined amount of time. In some implementations, the mobile device 102 is part of a group of trusted devices that receive the authorization. For example, the mobile device 102 is associated with a specific user account.

At 904, tracking information is received indicating a location of the tracking tag from the mobile device. For example, the tracking manager 114 receives tracking information 122 indicating a location of the tracking tag from the mobile device 102. In some implementations, the tracking manager 114 causes display of a communication interface to facilitate communication related to the tracking information 122.

At 906, the tracking information is displayed in a user interface. For example, the tracking manager 114 causes display of the tracking information a user interface. In some implementations, the user interface includes a map 302 indicating the location of the tracking tag. Additionally or alternatively, the user interface includes an indication of one or more directions 402 to locate the tracking tag.

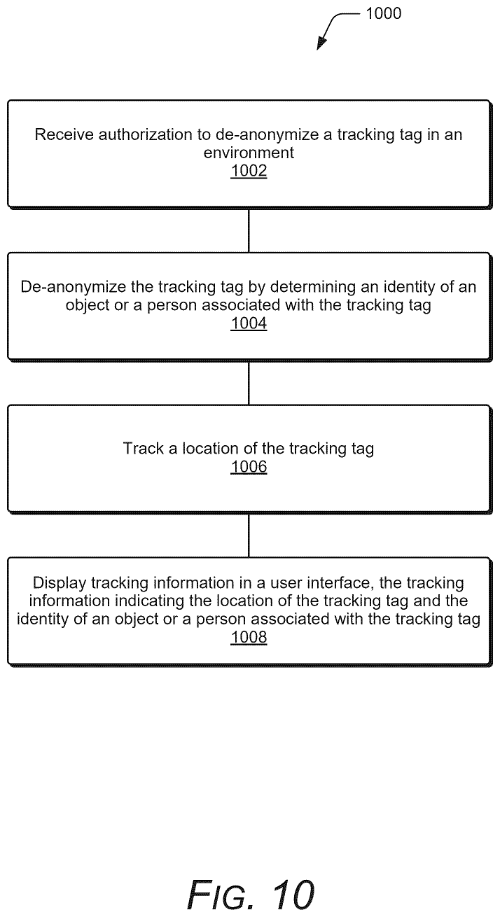

FIG. 10 illustrates example method(s) 1000 for authorization to de-anonymize a tracking tag. The order in which the method is described is not intended to be construed as a limitation, and any number or combination of the described method operations may be performed in any order to perform a method, or an alternate method.

At 1002, authorization is received to de-anonymize a tracking tag in an environment. For example, a tracking manager 114 receives authorization to de-anonymize a tracking tag 106 in an environment. In some implementations, the mobile device 102 is part of a group of trusted devices that receive the authorization from the additional mobile device 104. For example, the mobile device 102 is associated with a specific user account that is known to the additional mobile device 104.

At 1004, the tracking tag is de-anonymized by determining an identity of an object or a person associated with the tracking tag. For example, the tracking manager 114 de-anonymizes the tracking tag by determining an identity of an object or a person associated with the tracking tag.

At 1006, a location of the tracking tag is tracked. For example, the tracking manager 114 tracks a location of the tracking tag. In some implementations, the tracking manager 114 tracks the location of the tracking tag for a predetermined amount of time and terminates the authorization at an expiration of the predetermined amount of time.

At 1008, tracking information is displayed in a user interface, the tracking information indicating the location of the tracking tag and the identity of the object or the person associated with the tracking tag. For example, the tracking manager 114 causes display of tracking information 122 in a user interface, the tracking information 122 indicating the location of the tracking tag and the identity of the object or the person associated with the tracking tag. In some implementations, the tracking manager 114 the tracking manager sends instructions to a display device to initiate display of a communication interface to facilitate communication related to the tracking information 122. Additionally, in some implementations the user interface includes a map 302 indicating the location of the tracking tag or an indication of one or more directions 402 to locate the tracking tag.

FIG. 11 illustrates various components of an example device 1100, which can implement aspects of the techniques and features for authorization to de-anonymize a tracking tag, as described herein. The example device 1100 may be implemented as any of the devices described with reference to the previous FIGS. 1-10, such as any type of a wireless device, mobile device, mobile phone, flip phone, client device, companion device, display device, tablet, computing, communication, entertainment, gaming, media playback, and/or any other type of computing and/or electronic device. For example, the mobile device 102 described with reference to FIGS. 1-10 may be implemented as the example device 1100.

The example device 1100 can include various, different communication devices 1102 that enable wired and/or wireless communication of device data 1104 with other devices. The device data 1104 can include any of the various devices' data and content that is generated, processed, determined, received, stored, and/or communicated from one computing device to another. Generally, the device data 1104 can include any form of audio, video, image, graphics, and/or electronic data that is generated by applications executing on a device. The communication devices 1102 can also include transceivers for cellular phone communication and/or for any type of network data communication.

The example device 1100 can also include various, different types of data input/output (I/O) interfaces 1106, such as data network interfaces that provide connection and/or communication links between the devices, data networks, and other devices. The data I/O interfaces 1106 may be used to couple the device to any type of components, peripherals, and/or accessory devices, such as a computer input device that may be integrated with the example device 1100. The I/O interfaces 1106 may also include data input ports via which any type of data, information, media content, communications, messages, and/or inputs may be received, such as user inputs to the device, as well as any type of audio, video, image, graphics, and/or electronic data received from any content and/or data source.

The example device 1100 includes a processor system 1108 of one or more processors (e.g., any of microprocessors, controllers, and the like) and/or a processor and memory system implemented as a system-on-chip (SoC) that processes computer-executable instructions. The processor system 1108 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 1110. The example device 1100 may also include any type of a system bus or other data and command transfer system that couples the various components within the device. A system bus can include any one or combination of different bus structures and architectures, as well as control and data lines.

The example device 1100 also includes memory and/or memory devices 1112 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 1112 include volatile memory and non-volatile memory, fixed and removable media devices, and any suitable memory device or electronic data storage that maintains data for computing device access. The memory devices 1112 can include various implementations of random-access memory (RAM), read-only memory (ROM), flash memory, and other types of storage media in various memory device configurations. The example device 1100 may also include a mass storage media device.

The memory devices 1112 (e.g., as computer-readable storage memory) provide data storage mechanisms, such as to store the device data 1104, other types of information and/or electronic data, and various device applications 1114 (e.g., software applications and/or modules). For example, an operating system 1116 may be maintained as software instructions with a memory device 1112 and executed by the processor system 1108 as a software application. The device applications 1114 may also include a device manager, such as any form of a control application, software application, signal-processing and control module, code that is specific to a particular device, a hardware abstraction layer for a particular device, and so on.

In this example, the device 1100 includes a tracking manager 1118 that implements various aspects of the described features and techniques described herein. The tracking manager 1118 may be implemented with hardware components and/or in software as one of the device applications 1114, such as when the example device 1100 is implemented as the mobile device 102 described with reference to FIGS. 1-10. An example of the tracking manager 1118 is the tracking manager 114 implemented by the mobile device 102, such as a software application and/or as hardware components in the mobile device. In implementations, the tracking manager 1118 may include independent processing, memory, and logic components as a computing and/or electronic device integrated with the example device 1100.

The example device 1100 can also include a microphone 1120 and/or camera devices 1122, as well as device sensors 1124, such as may be implemented as components of an inertial measurement unit (IMU). The device sensors 1124 may be implemented with various sensors, such as a gyroscope, an accelerometer, and/or other types of motion sensors to sense motion of the device. The device sensors 1124 can generate sensor data vectors having three-dimensional parameters (e.g., rotational vectors in x, y, and z-axis coordinates) indicating location, position, acceleration, rotational speed, and/or orientation of the device. The example device 1100 can also include one or more power sources 1126, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 1100 can also include an audio and/or video processing system 1128 that generates audio data for an audio system 1130 and/or generates display data for a display system 1132. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 1100. Alternatively, the audio system and/or the display system are external, peripheral components to the example device.

Although implementations for authorization to de-anonymize a tracking tag have been described in language specific to features and/or methods, the appended claims are not necessarily limited to the specific features or methods described. Rather, the specific features and methods are disclosed as example implementations for authorization to de-anonymize a tracking tag, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a mobile device, including: at least one memory, and at least one processor coupled with the at least one memory and configured to cause the mobile device to: receive authorization from an additional mobile device to de-anonymize an identity of a tracking tag in an environment of the mobile device, identify the tracking tag in the environment of the mobile device, track a location of the tracking tag, and display tracking information in a user interface of the mobile device, the tracking information indicating at least the location of the tracking tag and the identity of the tracking tag.

In some aspects, the techniques described herein relate to a mobile device, wherein the tracking tag is an ultra-wideband (UWB) tag.

In some aspects, the techniques described herein relate to a mobile device, wherein the at least one processor is configured to cause the mobile device to track the location of the tracking tag for a predetermined amount of time.

In some aspects, the techniques described herein relate to a mobile device, wherein the at least one processor is configured to cause the mobile device to automatically terminate the authorization at an expiration of the predetermined amount of time.

In some aspects, the techniques described herein relate to a mobile device, wherein the mobile device is part of a group of trusted devices that receive the authorization from the additional mobile device.

In some aspects, the techniques described herein relate to a mobile device, wherein the mobile device is associated with a specific user account that is known to the additional mobile device.

In some aspects, the techniques described herein relate to a mobile device, wherein the at least one processor is configured to cause the mobile device to display a communication interface to facilitate communication related to the tracking information with the additional mobile device.

In some aspects, the techniques described herein relate to a mobile device, wherein the user interface includes a map indicating the location of the tracking tag or an indication of one or more directions to locate the tracking tag.

In some aspects, the techniques described herein relate to a method, including: transmitting, to a mobile device, authorization to de-anonymize an identity of a tracking tag in an environment of the mobile device, receiving tracking information indicating a location of the tracking tag from the mobile device, and displaying the tracking information in a user interface.

In some aspects, the techniques described herein relate to a method, further including de-anonymizing the identity of the tracking tag for a predetermined amount of time.

In some aspects, the techniques described herein relate to a method, further including automatically terminating the authorization at an expiration of the predetermined amount of time.

In some aspects, the techniques described herein relate to a method, wherein the mobile device is part of a group of trusted devices that receive the authorization.

In some aspects, the techniques described herein relate to a method, wherein the mobile device is associated with a specific user account.

In some aspects, the techniques described herein relate to a method, further including displaying a communication interface to facilitate communication related to the tracking information.

In some aspects, the techniques described herein relate to a method, wherein the user interface includes a map indicating the location of the tracking tag.

In some aspects, the techniques described herein relate to a method, wherein the user interface includes an indication of one or more directions to locate the tracking tag.

In some aspects, the techniques described herein relate to a system, including: a memory to maintain identities of at least one or more objects or people associated with tracking tags in an environment, and a tracking manager to: receive authorization to de-anonymize a tracking tag in the environment, de-anonymize the tracking tag by determining an identity of an object or a person associated with the tracking tag, track a location of the tracking tag, and display tracking information in a user interface, the tracking information indicating the location of the tracking tag and the identity of the object or the person associated with the tracking tag.

In some aspects, the techniques described herein relate to a system, wherein the tracking manager is configured to track the location of the tracking tag for a predetermined amount of time and to terminate the authorization at an expiration of the predetermined amount of time.

In some aspects, the techniques described herein relate to a system, wherein the tracking manager is configured to send instructions to a display device to initiate display of a communication interface to facilitate communication related to the tracking information.

In some aspects, the techniques described herein relate to a system, wherein the user interface includes a map indicating the location of the tracking tag or an indication of one or more directions to locate the tracking tag.

1. A mobile device, comprising:
at least one memory; and
at least one processor coupled with the at least one memory and configured to cause the mobile device to:
receive authorization from an additional mobile device to de-anonymize an identity of a tracking tag in an environment of the mobile device;
identify the tracking tag in the environment of the mobile device;
track a location of the tracking tag; and
display tracking information in a user interface of the mobile device, the tracking information indicating at least the location of the tracking tag and the identity of the tracking tag.

2. The mobile device of claim 1, wherein the tracking tag is an ultra-wideband (UWB) tag.

3. The mobile device of claim 1, wherein the at least one processor is configured to cause the mobile device to track the location of the tracking tag for a predetermined amount of time.

4. The mobile device of claim 3, wherein the at least one processor is configured to cause the mobile device to automatically terminate the authorization at an expiration of the predetermined amount of time.

5. The mobile device of claim 1, wherein the mobile device is part of a group of trusted devices that receive the authorization from the additional mobile device.

6. The mobile device of claim 1, wherein the mobile device is associated with a specific user account that is known to the additional mobile device.

7. The mobile device of claim 1, wherein the at least one processor is configured to cause the mobile device to display a communication interface to facilitate communication related to the tracking information with the additional mobile device.

8. The mobile device of claim 1, wherein the user interface includes a map indicating the location of the tracking tag or an indication of one or more directions to locate the tracking tag.

9. A method, comprising:
transmitting, to a mobile device, authorization to de-anonymize an identity of a tracking tag in an environment of the mobile device;
receiving tracking information indicating a location of the tracking tag from the mobile device; and
displaying the tracking information in a user interface.

10. The method of claim 9, further comprising de-anonymizing the identity of the tracking tag for a predetermined amount of time.

11. The method of claim 10, further comprising automatically terminating the authorization at an expiration of the predetermined amount of time.

12. The method of claim 9, wherein the mobile device is part of a group of trusted devices that receive the authorization.

13. The method of claim 9, wherein the mobile device is associated with a specific user account.

14. The method of claim 9, further comprising displaying a communication interface to facilitate communication related to the tracking information.

15. The method of claim 9, wherein the user interface includes a map indicating the location of the tracking tag.

16. The method of claim 9, wherein the user interface includes an indication of one or more directions to locate the tracking tag.

17. A system, comprising:
a memory to maintain identities of at least one or more objects or people associated with tracking tags in an environment; and
a tracking manager to:
receive authorization to de-anonymize a tracking tag in the environment;
de-anonymize the tracking tag by determining an identity of an object or a person associated with the tracking tag;
track a location of the tracking tag; and
display tracking information in a user interface, the tracking information indicating the location of the tracking tag and the identity of the object or the person associated with the tracking tag.

18. The system of claim 17, wherein the tracking manager is configured to track the location of the tracking tag for a predetermined amount of time and to terminate the authorization at an expiration of the predetermined amount of time.

19. The system of claim 17, wherein the tracking manager is configured to send instructions to a display device to initiate display of a communication interface to facilitate communication related to the tracking information.

20. The system of claim 17, wherein the user interface includes a map indicating the location of the tracking tag or an indication of one or more directions to locate the tracking tag.
